(19) United States
(12) Patent Application Publication
(10) Pub. No.: US 2005/0173332 A1
(43) Pub. Date: Aug. 11, 2005

(54) Method and device for sealing end portion of porous structure, and porous structure sealed at end portion

(75) Inventor: Kazuhiko Hidaka, Kani-gun (JP)

Correspondence Address: PARKHURST & WENDEL, L.L.P., 1421 PRINCE STREET, SUITE 210, ALEXANDRIA, VA, 22314-2805, US

(73) Assignee: NGK Insulators, Ltd., Nagoya-city (JP)

(21) Appl. No.: 11/050,863

(22) Filed: Feb. 7, 2005

(30) Foreign Application Priority Data
Feb. 9, 2004 (JP) 2004-031842

(51) Int. Cl. B01D 39/20

(52) U.S. Cl. 210/348; 210/510.1; 210/541; 277/918

(57) ABSTRACT

There are disclosed a method and a device for sealing an end portion of a porous structure having a columnar outer shape, such as a ceramic honeycomb filter, with a sealing material, so that the whole end portion can be uniformly coated with the sealing material, and a porous structure sealed at an end portion in a superior state by the method. In the method, an end portion of a porous structure 9 is sealed at an end face of the porous structure 9 having a columnar outer shape. A porous elastic material 13 having a predetermined thickness adhered on a planar base plate 15 is impregnated with a slurried sealing material, the porous elastic material 13 is pressed onto the end face of the porous structure 9 to coat the end portion of the porous structure 9 with the sealing material.

### BACKGROUND OF THE INVENTION

1. Field of the Invention

The present invention relates to a method for sealing an end portion of a porous structure whose outer shape is columnar, such as a ceramic honeycomb filter for use in filtering a fluid, with a sealing material, a device for use in the sealing, and a sealed porous structure.

2. Description of the Related Art

In recent years, a ceramic honeycomb filter using a honeycomb substrate having a plurality of cells (through-holes) partitioned by porous partition walls has been broadly used as a filter for solid/liquid separation or gas/solid separation (see, e.g., JP-A-2002-153117). Since this ceramic honeycomb filter is superior in physical strength, durability, resistance to corrosion and the like as compared with an organic polymer membrane or the like for use in a similar application, the filter is preferably used in removing suspended matters, bacteria, powder dust and the like in a liquid or a gas in broad fields such as water purification, exhaust gas treatment, and medicine/food field.

This ceramic honeycomb filter has a porous structure in which a filter layer having a desired filtering capability is directly formed on an inner surface of a cell of the substrate or in which one or more intermediate layers having a pore diameter adjusted into a middle degree between pore diameters of the substrate and the filter layer are formed between the substrate and the filter layer.

A fluid to be treated supplied into the cells of the ceramic honeycomb filter is filtered through the filter layer, and thereafter passes through pores of the intermediate layer and pores of the substrate to flow out to an external space. At the end face of the ceramic honeycomb filter, the end portion of the substrate needs to be sealed with a sealing material in order to prevent the fluid to be treated from flowing directly into the filter through the pores of the end portions of the partition wall at the end face of the filter and from flowing out to the outside without being filtered by the filter layer. FIG. 10 is a partially enlarged sectional view showing a state of this end portion. The end portion of a substrate (partition wall portion) 1 is sealed together with the end portions of an intermediate layer 3 and a filter layer 5 by a sealing material 11.

This sealing of the end portion is obtained by applying the sealing material to the substrate end portion of the ceramic honeycomb filter. The sealing material has heretofore been applied to the substrate end portion of the ceramic honeycomb filter by spraying the slurried sealing material toward the filter end face. Therefore, it has been difficult to uniformly apply the sealing material to the whole end portion, and it has been difficult to obtain a satisfactory sealing because of unevenness generated in the sealing of the end portion. Furthermore, there has also been a problem that the sealing material flies/scatters, accordingly operation environment deteriorates, and costs increase.

### SUMMARY OF THE INVENTION

The present invention has been developed in consideration of the conventional situations, and aimed at providing a method for sealing an end portion of a porous structure, capable of uniformly applying the sealing material to the whole end portion in a case where the end portion of the porous structure having a columnar outer shape, such as a ceramic honeycomb filter, with a sealing material, a device for sealing an end portion capable of efficiently performing the method, and a porous structure whose end portion is sealed in a superior state by the method.

According to the present invention, there is provided a method for sealing an end portion of a porous structure having a columnar outer shape with a sealing material, the method comprising the steps of: impregnating a porous elastic material having a predetermined thickness adhered on a planar base plate with a slurried sealing material; and pressing the porous elastic material to the end face of the porous structure to apply the sealing material to the end portion of the porous structure.

Moreover, according to the present invention, there is provided a device for sealing an end portion of a porous structure, comprising: a holding mechanism which holds the porous structure having a columnar outer shape in a predetermined position; and a stamping mechanism, for holding a porous elastic material having a predetermined thickness adhered on a planar base plate in such a manner that a surface of the porous elastic material faces an end face of the porous structure held by the holding mechanism, moving the porous elastic material toward the end face of the porous structure, and pressing the porous elastic material onto the end face of the porous structure with a predetermined load.

Furthermore, according to the present invention, there is provided a porous structure sealed at an end portion by being coated with a sealing material, the porous structure having a columnar shape, wherein the sealing material is applied only to the end portion of the porous structure, and a deviation of a length of the applied sealing material in a length direction of the porous structure falls in a range of ±50% of a set length.

According to the method for sealing an end portion of the present invention, the sealing material can be uniformly applied to the whole end portion of the porous structure whose outer shape is columnar as in the ceramic honeycomb filter. Moreover, the sealing material is inhibited from being attached to a portion other than the end portion, the flying/scattering of the sealing material to the periphery is inhibited, accordingly working environment can be inhibited from being deteriorated, and the sealing material can be inhibited from being wasted. Furthermore, according to the device for sealing an end portion of the present invention, when the method for sealing the end portion is performed, working efficiency is enhanced. Moreover, when the porous elastic material impregnated with the sealing material is pressed onto the end face of the porous structure, a pressing load is easily controlled. Furthermore, when the end portion is sealed as in the porous structure of the present invention, there is little unevenness in the applied state of the sealing material of each end portion, and a satisfactory sealing is obtained over the whole end portion.

### BRIEF DESCRIPTION OF THE DRAWINGS

FIG. 1 is a front view showing an example of a shape of a porous elastic material for use in a method for sealing an end portion of the present invention;

FIG. 2 is a side view showing the example of the shape of the porous elastic material for use in the method for sealing the end portion of the present invention;

FIG. 3 is an explanatory view showing a method for impregnating the porous elastic material with slurry;

FIG. 4 is an explanatory view showing a method for pressing sponge onto the end face of the porous structure;

FIG. 5 is a partially enlarged sectional view showing an ideal applied state of the sealing material;

FIG. 6 is a partially enlarged sectional view showing an example of the applied state of the sealing material in the first pressing in a case where the porous elastic material is pressed onto the end face of the ceramic honeycomb filter twice while changing a load;

FIG. 7 is a partially enlarged sectional view showing an example of the applied state of the sealing material in the second pressing in a case where the porous elastic material is pressed onto the end face of the ceramic honeycomb filter twice while changing the load;

FIG. 8 is a schematic diagram showing one example of an embodiment of an device for sealing an end portion of the present invention;

FIG. 9 is a graph showing a result of an example; and

FIG. 10 is a partially enlarged sectional view showing a state of a sealed end portion of the ceramic honeycomb filter.

### DESCRIPTION OF THE PREFERRED EMBODIMENT

As described above, in a method for sealing an end portion of a porous structure of the present invention, the end portion of the porous structure is sealed with a sealing material at an end face of the porous structure whose outer shape is columnar. In a characteristic constitution, a porous elastic material having a predetermined thickness adhered on a planar base plate is impregnated with a slurried sealing material, and the porous elastic material is pressed onto the end face of the porous structure to thereby apply the sealing material to the end portion of the porous structure. The method for sealing an end portion of the present invention will be described hereinafter with reference to the drawings.

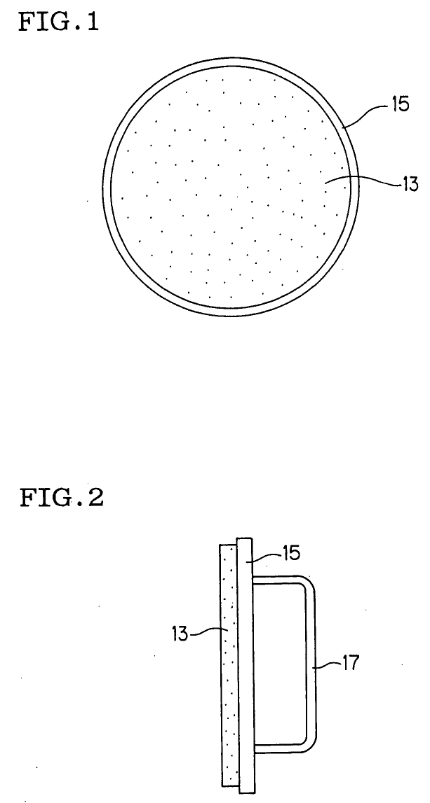

FIGS. 1 and 2 are a front view and a side view showing one example of a shape of the porous elastic material for use in the method for sealing an end portion of the present invention. The porous elastic material for use in the present invention has appropriate elasticity, and is capable of being impregnated with the slurried sealing material and holding it in the pores. Concretely, for example, sponge is preferably usable. A porous elastic material 13 has a predetermined uniform thickness, and is used in a adhered state on a planar base plate 15 by a double-faced tape or the like. It is to be noted that a grasping portion (or portions) such as a handle (or handles) 17 is/are preferably disposed on the surface of the base plate 15 opposite to a surface on which the porous elastic material 13 is adhered to facilitate the handling. The porous elastic material 13 has such a dimension (area, shape) that the surface of the porous elastic material is capable of covering the end face of the porous structure to be sealed.

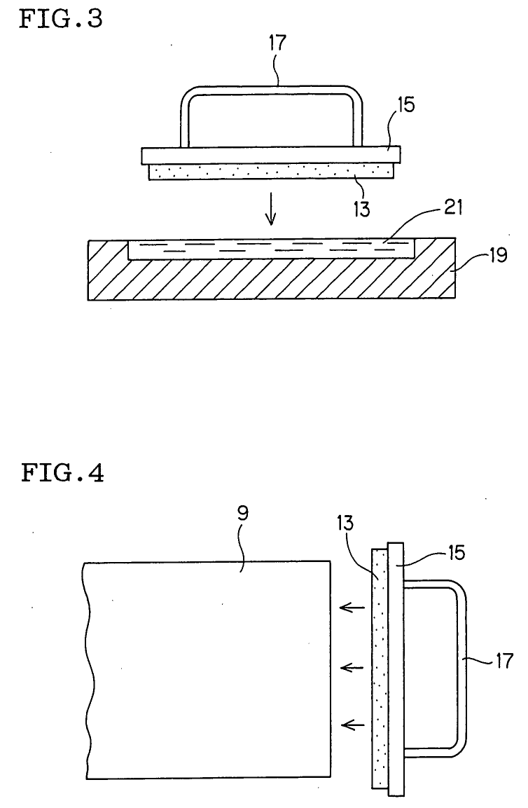

In the method for sealing an end portion of the present invention, first the porous elastic material 13 is impregnated with a slurried sealing material (hereinafter referred to simply as “slurry”). In this case, an impregnating container 19 is preferably used whose inner bottom surface is planar as shown in FIG. 3, so that all portions of the porous elastic material 13 are uniformly impregnated with the slurry without any deviation. Slurry 21 is put into the impregnating container 19 by a predetermined depth, and the porous elastic material 13 is immersed in the slurry 21 in the impregnating container 19 to impregnate the porous elastic material 13 with a desired amount of slurry.

Next, as shown in FIG. 4, the surface of the porous elastic material 13 impregnated with the slurry is disposed facing the end face of a porous structure 9 which is to be sealed, a load is applied to the surface of the base plate 15 opposite to a surface on which the porous elastic material 13 is adhered, and the porous elastic material is pressed onto the end face of the porous structure 9. By this operation, the porous elastic material 13 is compressed, and the slurry with which the porous elastic material 13 has been impregnated exudes, and is applied to the end portion of the porous structure 9.

When the sealing material is applied in such a method, the whole end portion of the porous structure can be substantially uniformly coated with the sealing material. Therefore, unevenness may not be generated in the sealing of each end portion, and a satisfactory sealing can obtained. Furthermore, the sealing material may not fly/scatter or stick to the portion other than the end portion. Therefore, since the working environment may not deteriorate, and the sealing material may not be wasted, costs for sealing the end portion can be suppressed.

The applied state of the sealing material can be controlled by the thickness or pore state of the porous elastic material for use, viscosity or impregnating amount of slurry, load in pressing the porous elastic material onto the end face of the porous structure, pressing time, pressing times and the like.

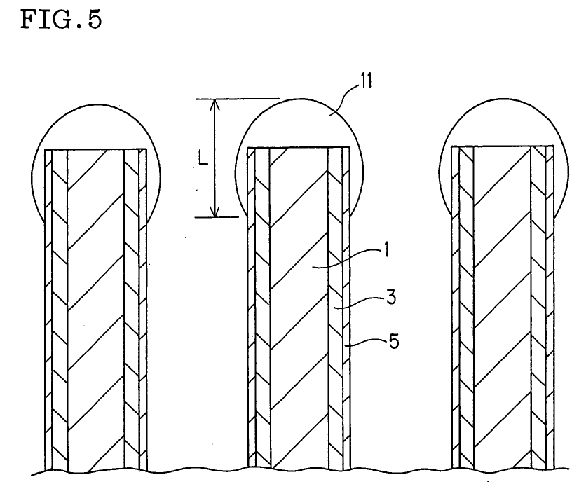

FIG. 5 is a partially enlarged sectional view showing an ideal applied state of the sealing material in a case where the porous structure which is to be sealed is a ceramic honeycomb filter using a honeycomb substrate having a plurality of cells partitioned by porous partition walls. In this ceramic honeycomb filter, a filter layer 5 is formed on an inner surface of a cell of a substrate (partition wall portion) 1 via an intermediate layer 3. As a concrete applied state of the sealing material, after drying the applied sealing material, a deviation of a length L of a sealing material 11 applied as shown in FIG. 5 in a length direction of a porous structure ideally falls in a range of ±50% of a set length. For example, when the length is set to 2 mm, the length L of the applied sealing material in the length direction of the porous structure preferably falls in a range of 1 to 3 mm in the whole end face. In this applied state, there is little unevenness in the sealing of the whole end portion, and a satisfactory sealing is obtained.

It is to be noted that the porous elastic material may be repeatedly pressed a plurality of times in a case where the above-described ideal applied state is not obtained by one pressing of the porous elastic material impregnated with the slurry. In this case, the impregnating amount of the slurry or the pressing load may be changed.

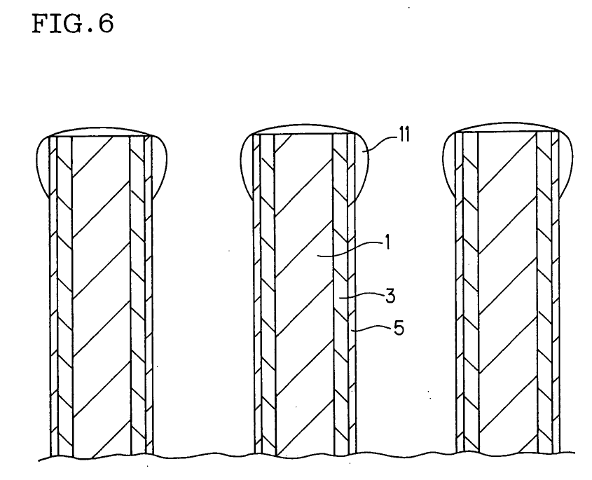

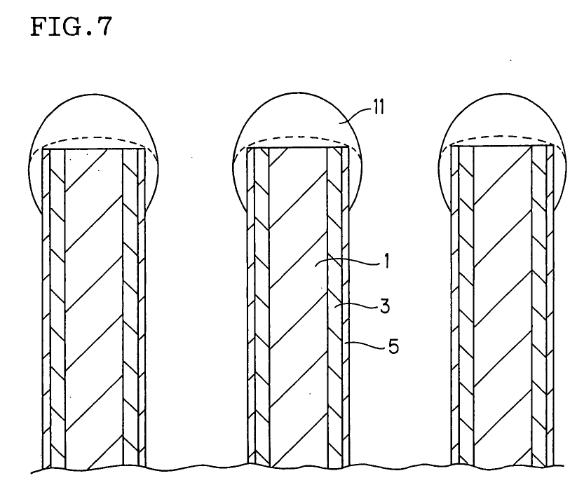

For example, at the first press of the porous elastic material, the material is pressed with a comparatively large load, so that a large amount of the sealing material 11 is applied in an inner direction of the ceramic honeycomb filter from the end face of the substrate 1 as shown in FIG. 6. Thereafter, at the second press of the porous elastic material, the material is pressed with a comparatively small load, so that the sealing material 11 is mainly applied to the end face of the substrate 1 as shown in FIG. 7. Accordingly, it is possible to obtain an ideal applied state.

In the sealing material for use in the present invention, a material similar to a material which has heretofore been used in sealing the end portion of the ceramic honeycomb filter is usable. For example, water, binder components and the like are added to a glass frit which has heretofore been used in the sealing material for sealing the end portion of the ceramic honeycomb filter by spraying, and formed into slurry. A porous elastic material such as sponge is impregnated with the slurry as described above, and the slurry can be used in this manner in sealing the end portion. It is to be noted that a frit amount needs to be suppressed to a certain degree to thereby lower viscosity in the spraying. However, in the present invention, the frit amount is preferably further increased to thereby appropriately raise the viscosity.

The material or the pore diameter of the porous structure which is to be sealed at the end portion is not especially limited, and can be appropriately selected in accordance with an application, use environment or the like. When the porous structure is the ceramic honeycomb filter, for a purpose of increasing a permeate flow, for example, as in a filter described in JP-A-2000-153117, an improved honeycomb structure having a slit-shaped hollow portion may be used as the porous structure of the present invention.

When the method for sealing an end portion of the present invention is performed, as shown in FIG. 2, a handle (or handles) 17 is/are preferably attached to the surface of a base plate 15 opposite to the surface on which sponge 13 is adhered, and the porous elastic material may be manually pressed onto the end face of the porous structure, but a device for sealing an end portion of the present invention is preferably used as follows.

A device for sealing an end portion of the present invention has: a holding mechanism which holds a porous structure having a columnar outer shape in a predetermined position; and a stamping mechanism which holds a porous elastic material having a predetermined thickness adhered on a planar base plate in such a manner that the surface of the porous elastic material faces the end face of the porous structure held by the holding mechanism, which moves the porous elastic material toward the end face of the porous structure, and which presses the porous elastic material onto the end face of the porous structure with a predetermined load.

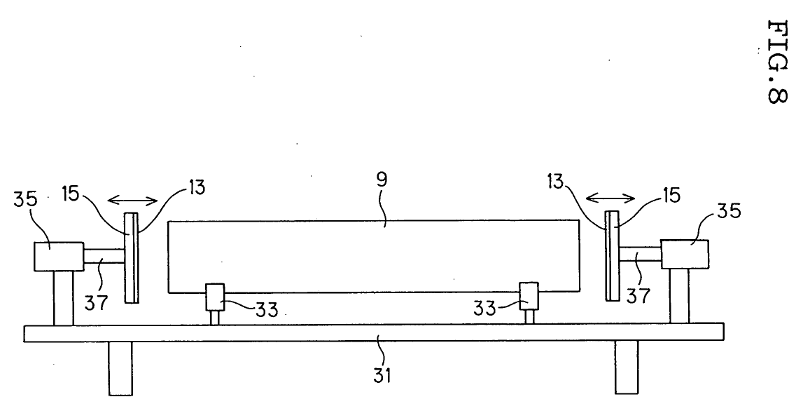

FIG. 8 is a schematic diagram showing one example of an embodiment of the device for sealing an end portion of the present invention. In the present example, as the holding mechanism, roller receiving bases 33 are disposed on a base 31 of the device, and a porous structure 9 whose end portion is to be sealed is held in a predetermined position on the base 31 by the roller receiving bases 33 in such a manner that a length direction of the porous structure is substantially horizontal. Moreover, as the stamping mechanism, air cylinders 35 which expand/contract in the horizontal direction are disposed on opposite end-face sides of the porous structure 9 held by the roller receiving bases 33, and porous elastic materials 13 such as sponge adhered on planar base plates 15 are attached to ends of shafts 37 of the air cylinders 35, and held in such a manner that the surfaces of the porous elastic materials 13 face the end faces of the porous structure 9. Moreover, while this state is held, the air cylinders 35 are driven, accordingly the porous elastic materials 13 are moved toward the end faces of the porous structure 9, and pressed onto the end faces of the porous structure 9 with predetermined loads.

In the device for sealing an end portion of the present invention, the porous elastic material 13 adhered on planar base plate 15 is preferably easily and detachably attached to the air cylinder 35 in such a manner that a slurry impregnating operation performed in a detached state of the porous elastic material from the device is quickly shifted from/to a pressing operation performed in an attached state of the porous elastic material to the device. A cylinder pressure of the air cylinder 35 is preferably controllable by a regulator.

When the method for sealing an end portion of the present invention is performed using the sealing device, the operation is efficiently performed, and productivity is enhanced. Moreover, since the control of the pressing load of the porous elastic material is facilitated, the porous elastic material can be pressed onto each porous structure with an equal pressing load when sealing the end portions of a plurality of porous structures, and a stable quality is obtained.

Next, a porous structure of the present invention will be described. The porous structure of the present invention is a porous structure whose end portion is sealed by being coated with a sealing material, and whose outer shape is columnar. In a characteristic constitution, the sealing material is applied only to the end portion of the porous structure, and a deviation of a length of the applied sealing material in a length direction of the porous structure falls in a range of ±50% of a set length.

Such a sealing of the end portion can be obtained by the method for sealing an end portion of the present invention. When the sealing material is applied only to the end portion of the substrate, and does not stick to a portion other than the end portion, the sealing material does not adversely influence the performance of the porous structure. When the deviation of the length of the applied sealing material in a length direction of the porous structure falls in a range of ±50% of the set length, there is little unevenness in the sealing of the whole end portion, and a satisfactory sealing is obtained.

In the present invention, there is no special restriction as to a porous structure which is to be sealed at the end portion, and the present invention may be applied to any porous structure whose outer shape is columnar as long as pores in the end portion need to be sealed with the sealing material at one end face or both end faces of the porous structure. Especially, examples of the porous structure to which the present invention is preferably applicable include a ceramic honeycomb filter using a honeycomb substrate having a plurality of cells partitioned by porous partition walls.

### EXAMPLE

The present invention will be described hereinafter in further detail in accordance with an example, but the present invention is not limited to the example.

An end portion of an alumina honeycomb structure whose outer shape was cylindrical (diameter: 180 mm, length: 1000 mm, cell shape: hexagonal shape, cell number: 2000 cells, partition wall thickness: 0.7 mm, average pore diameter: 0.1 μm) was coated with a sealing material using sponge (diameter: 210 mm, thickness: 10 mm) adhered on a base plate as shown in FIGS. 1 and 2. For the sealing material, a glass frit (average particle diameter: 15 μm) having a composition of SiO₂: 70 mass %, Al₂O₃: 1 mass %, K₂O: 3 mass %, Na₂O₃: 10 mass %, ZrO₂: 16 mass % was used. A 2% solution of an organic binder for keeping dry strength was added at a ratio of 9:10 (mass ratio), and the material was formed into slurry. The slurry was put into an impregnating container as shown in FIG. 3 to thereby impregnate the sponge with about 10 g of the slurry. The sponge was pressed onto the end face of the honeycomb structure with a load of 20 kg for five seconds. It is to be noted that this applying operation was performed for setting a length of an applied sealing material in a length direction of the honeycomb structure to 2 mm after drying.

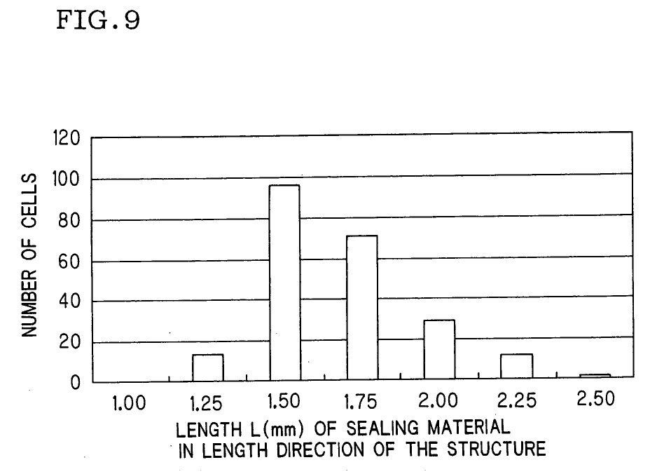

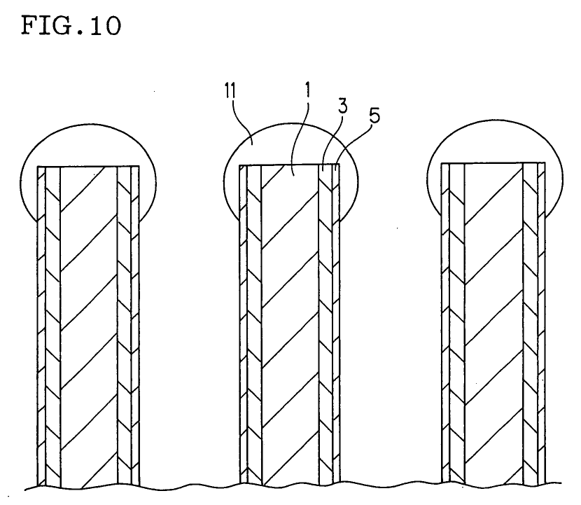

After the sealing material applied to the end portion of the honeycomb structure was dried, 222 cells were optionally selected, and length L (see FIG. 5) of the applied sealing material in the length direction of the honeycomb structure was measured at the end portion of the partition walls surrounding each cell. Results are shown in a graph (histogram) of FIG. 9. The length L of the applied sealing material in the length direction of the honeycomb structure was in a range of 1.25 to 2.50 mm, and in a range of ±50% (±1 mm) of a set length (2 mm) which was a target in all measurement positions, and an ideal sealing of the end portion was obtained. Any sealing material attached to a portion other than the honeycomb structure end portion was not observed.

The present invention is preferably applicable in sealing an end portion of a porous structure whose outer shape is columnar and whose pores in an end portion need to be sealed with a sealing material at one end face or both end faces, for example, a ceramic honeycomb filter.

1. A method for sealing an end portion of a porous structure having a columnar outer shape with a sealing material, the method comprising the steps of:
impregnating a porous elastic material having a predetermined thickness adhered on a planar base plate with a slurried sealing material; and
pressing the porous elastic material to the end face of the porous structure to apply the sealing material to the end portion of the porous structure.

2. The method for sealing the end portion of the porous structure according to claim 1, wherein the porous structure having the columnar outer shape is a ceramic honeycomb filter using a honeycomb substrate having a plurality of cells partitioned by porous partition walls.

3. The method for sealing the end portion of the porous structure according to claim 1, wherein the porous elastic material is sponge.

4. A device for sealing an end portion of a porous structure, comprising:
a holding mechanism which holds the porous structure having a columnar outer shape in a predetermined position; and
a stamping mechanism, for holding a porous elastic material having a predetermined thickness adhered on a planar base plate in such a manner that a surface of the porous elastic material faces an end face of the porous structure held by the holding mechanism, moving the porous elastic material toward the end face of the porous structure, and pressing the porous elastic material onto the end face of the porous structure with a predetermined load.

5. The device for sealing the end portion of the porous structure according to claim 4, wherein the porous structure having the columnar outer shape is a ceramic honeycomb filter using a honeycomb substrate having a plurality of cells partitioned by porous partition walls.

6. The device for sealing the end portion of the porous structure according to claim 4, wherein the porous elastic material is sponge.

7. A porous structure sealed at an end portion by being coated with a sealing material, the porous structure having a columnar shape,
wherein the sealing material is applied only to the end portion of the porous structure, and a deviation of a length of the applied sealing material in a length direction of the porous structure falls in a range of ±50% of a set length.

8. The porous structure according to claim 7, wherein the porous structure is a ceramic honeycomb filter using a honeycomb substrate having a plurality of cells partitioned by porous partition walls.
